(19) United States
(12) Patent Application Publication
(10) Pub. No.: US 2015/0361334 A1
(43) Pub. Date: Dec. 17, 2015

(54) PROCESS FOR PREPARING CARBON QUANTUM DOTS USING EMULSION

(71) Applicant: POSTECH ACADEMY-INDUSTRY FOUNDATION, Pohang-si (KR)

(72) Inventors: Woosung KWON, Seoul (KR); Shi Woo RHEE, Pohang-si (KR)

(21) Appl. No.: 14/307,774

(22) Filed: Jun. 18, 2014

(30) Foreign Application Priority Data
Jun. 16, 2014 (KR) 10-2014-0073099

(51) Int. Cl. C09K 11/06

(52) U.S. Cl. CPC C09K 11/06; C09K 2211/10

(57) ABSTRACT

The present invention provides a process for preparing carbon quantum dots having uniform size by using emulsion, and a process for doping the inside of the carbon structure with other element or replacing the surface with a surface stabilizer having a specific chemical functional group different from existing stabilizers in order to control the properties of the carbon quantum dots. The process for preparing the carbon quantum dots according to the present invention makes a mass production possible and the process thereof is simple. Furthermore, the process is easy to control the size of the quantum dots and the reaction yield rate of the method is excellent. In addition, according to the present invention, it is possible to synthesize carbon quantum dots having uniform size and superior quantum yield rate and it makes it possible to embody the color as equivalent to existing molecular chromophores or heavy metal quantum dots by changing the structure of the chromophore.

### TECHNICAL FIELD

The present invention relates to a process for preparing carbon quantum dots having excellent optical and electric characteristics and durability. Particularly, the present invention relates to a mass production method of carbon quantum dots having uniform size by using an emulsion and a method of doping the inside of the carbon structure with other elements or substituting the surface of the same with a surface stabilizer having a specific chemical functional group different from an existing stabilizer in order to control the properties of the carbon quantum dots.

### BACKGROUND ART

Studies about the characteristics and the applications of various kinds of semiconductor nanoparticles have been accomplished since the team of professor Bawendi of MIT in the U.S. synthesized cadmium-based semiconductor nanoparticles in 1993.

In 1996, the team of professor Alivisatos of UC Berkeley in the U.S. revealed that it is possible to control band gap by controlling the size of semiconductor nanoparticles, and named the particles having such characteristics specifically “quantum dot”.

Generally, the quantum dot shows excellent optical and electric characteristics and durability but it has a disadvantage of requiring poisonous and expensive heavy metals as the raw material and a synthesis process of high temperature. Therefore, studies for synthesizing quantum dots from safe and cheap materials are being carried out, and recently the study about the method of synthesizing carbon-based quantum dots (carbon quantum dots) by treating carbon with various methods is largely receiving attention.

The carbon quantum dot was accidentally discovered in 2004 by the team of professor Scrivens of South Carolina University in the U.S. in the process of synthesizing carbon nanotubes, and a hydrothermal method that carbonizes an aqueous solution of glucoses, organic acid, and so on by applying pressure and heat to the same and an oxidation method that classifies carbon quantum dots from the debris obtained by chemically frittering graphite are mainly being used recently for synthesizing the same.

The carbon quantum dot has an advantage of the indices related to industrialization such as excellent properties, stability, low toxicity, cheap cost, and so on over the heavy metal quantum dot. However, it is difficult to obtain the particles of uniform size, its reaction yield rate and quantum yield rate are low, and its internal chemical structure and revelation process of optical characteristics are indefinite. In addition, the carbon quantum dot still can embody only the short-wavelength color of blue range in contrast with the heavy metal quantum dot which can embody various colors from blue to red, and thus the application is limited to relatively simple fields (imaging, sensor, and so on) to which color is of little important.

According to this, demands for a new synthesis method being able to control the size easily in the synthesis step, to produce the same in quantity, and to stabilize the surface of the carbon quantum dots at the same time, and a method being able to control the properties (particularly, the wavelength of the emitted light) of the carbon quantum dots have been continued.

### DISCLOSURE

### Objects of Invention

It is an aspect of the present invention to provide a new method capable of preparing carbon quantum dots in quantity through a simple preparation process.

It is another aspect of the present invention to provide a method capable of preparing carbon quantum dots having high reaction yield rate and high quantum yield rate by preventing the carbon quantum dots from aggregating in the preparation process.

It is still another aspect of the present invention to provide a method of preparing carbon quantum dots of uniform size by controlling the size of the carbon quantum dots arbitrarily.

It is still another aspect of the present invention to provide a simple method of doping carbon quantum dots without separate processes.

It is still another aspect of the present invention to provide a method of doping carbon quantum dots by using a compound composed of non-carbon elements.

It is still another aspect of the present invention to provide a method of doping carbon quantum dots so as to show different light emission characteristics from existing carbon quantum dots.

It is still another aspect of the present invention to provide a method of replacing the surface stabilizer of the carbon quantum dots of which the process is simple and the substitution ratio is excellent.

It is still another aspect of the present invention to provide a method of dissolving carbon quantum dots in all sorts of solvents (hydrophilic, oleophilic, and so on) by controlling the properties of the surface stabilizer of the carbon quantum dots through a method of replacing the surface stabilizer.

It is still another aspect of the present invention to provide a method of controlling the properties of carbon quantum dots by using a surface stabilizer which can function as a chromophore or an auxochrome.

It is still another aspect of the present invention to provide carbon quantum dots of uniform size having excellent optical and electric characteristics and durability.

### Means for Achieving the Objects

The present invention provides a process for preparing carbon quantum dots, including the steps of heating a dispersion solution including a carbon source compound and a surface stabilizer at 80 to 180° C. for 20 minutes or more to form an emulsion in which a carbon source is dispersed; and heating the emulsion at 200° C. or more for 90 minutes or more to carbonize the carbon source.

The present invention also provides a process for preparing carbon quantum dots, including the steps of heating a dispersion solution including a carbon source compound and a surface stabilizer at 80 to 180° C. for 20 minutes or more to form an emulsion in which a carbon source is dispersed; and heating the emulsion at 200° C. or more for 90 minutes or more to carbonize the carbon source, wherein the emulsion further includes a compound comprising one or more non-carbon elements selected from the group consisting of nitrogen, sulfur, phosphorus, boron, lithium, zinc, and aluminum.

The present invention provides a process for preparing carbon quantum dots, including the steps of heating a dispersion solution including a carbon source compound and a surface stabilizer at 80 to 180° C. for 20 minutes or more to form an emulsion in which a carbon source is dispersed; and heating the emulsion at 200° C. or more for 90 minutes or more to carbonize the carbon source, wherein the carbon source compound further includes one or more non-carbon elements selected from the group consisting of nitrogen, sulfur, phosphorus, boron, zinc, and aluminum.

The present invention also provides a process for preparing carbon quantum dots, including the steps of heating a dispersion solution including a carbon source compound and a surface stabilizer at 80 to 180° C. for 20 minutes or more to form an emulsion in which a carbon source is dispersed; and heating the emulsion at 200° C. or more for 90 minutes or more to carbonize the carbon source; and reacting the carbon quantum dots prepared through the carbonizing step with one or more surface stabilizers selected from the group consisting of a C₁-C₂₅ alkylamine, a C₀-C₂₅ alkylbenzylamine, a C₁-C₂₅ carboxylic acid, a C₁-C₂₅ alcohol, and a C₁-C₂₅ thiol to modify the surface of the carbon quantum dots.

The present invention also provides a carbon quantum dot prepared according to said method.

Hereinafter, according to concrete embodiments, the process for preparing carbon quantum dots and the carbon quantum dot prepared by such method are explained in more detail. However, the followings are only for the understanding of the present invention and the scope of the present invention is not limited to or by them, and it is obvious to a person skilled in the related art that the embodiments can be variously modified in the scope of the present invention.

In addition, “include” or “comprise” means to include any components (or ingredients) without particular limitation unless there is no particular mention about them in this description, and it cannot be interpreted as a meaning of excluding an addition of other components (or ingredients).

Generally, ‘carbon quantum dot’ means a quantum dot that carbon is its main component. Here, the ‘main component’ means that carbon atoms have the most weight or number in the ingredients of the quantum dot. More accurately, it means that the content of carbon atoms in the carbon quantum dots is 50 weight % or more, preferably 55 weight % or more, and more preferably 60 weight % or more. Recently, electrophoresis, laser ablation, thermal oxidation, electric oxidation, thermal degradation, and so on are being widely used for the synthesis of carbon quantum dots, but they are hard to obtain the particles of uniform size because the size control is difficult and do not get outcomes replaceable existing quantum dots because of low reaction yield rate and quantum yield rate.

Accordingly, the present inventors synthesized the carbon quantum dots with the processes of forming droplets including the carbon source simply and carbonizing the same wherein the droplets are dispersed with uniform size by thermal energy and maintain their stability during the processes, and recognized the uniform size and high reaction yield rate and quantum yield rate.

According to one embodiment of the invention, the present invention provides a process for preparing carbon quantum dots by heating an emulsion including the carbon source to carbonize the carbon source. Especially, the process for preparing carbon quantum dots of the present invention is characterized in heating the carbon source to carbonize the same after forming the emulsion in which the carbon source is dispersed without using additional surfactants.

In forming an emulsion in which a carbon source is dispersed, it is generally known to use a common surfactant. However, when the emulsion is formed by using such surfactant, there is a disadvantage that the surfactant makes it difficult to separate the initial reactants from the prepared carbon quantum dots in later purification process for eliminating the initial reactant and the yield rate of the total carbon quantum dots decreases remarkably. Particularly, the purification is carried out by using methanol to eliminate the other reactants such as a carbon reactant (i.e. citric acid), a surfactant (i.e. oleylamine), and the like, after synthesizing the carbon quantum dots. In this case, it is possible to separate the carbon quantum dots and the reactants from each other because the carbon quantum dots do not dissolved in methanol but the other reactants are dissolved in methanol. However, in the case of the synthesis using the surfactant, the methanol-insoluble carbon quantum dots also dissolved in methanol due to the surfactant and the yield rate becomes low. Accordingly, the present invention can improve the total reaction yield rate and the quantum yield rate because the emulsion in which the carbon source is dispersed is formed effectively without using a surfactant.

The process for preparing carbon quantum dots of the present invention includes the steps of heating a dispersion solution including a carbon source compound and a surface stabilizer at 80 to 180° C. for 20 minutes or more to form an emulsion in which a carbon source is dispersed; and heating the emulsion at 200° C. or more for 90 minutes or more to carbonize the carbon source.

First, the emulsion in which the carbon source is dispersed may be formed by heating the dispersion solution including the carbon source compound and the surface stabilizer at 80 to 180° C. for 20 mins or more or for 20 to 120 mins. The reaction temperature in the step for forming the emulsion also may be 85 to 170° C., and more preferably 90 to 160° C. The step for forming the emulsion also may be carried out for 25 mins or more or 25 to 110 mins, and more preferably for 30 mins or more or 30 to 100 mins.

The step for forming the emulsion may be carried out by heating the emulsion at 80° C. (degrees Celsius) or more for 20 mins or more so as to maximize the surface energy by providing sufficient thermal energy to the carbon source and form the emulsion in which the carbon source is dispersed effectively without using a surfactant. However, the step may be carried out at 180° C. or less for about 120 mins or less so that the succeeding step for carbonizing the carbon source is carried out effectively.

The step for forming the emulsion may be carried out under a slightly acid condition of pH 4 to 6, and preferably pH 4.5 to 5.5. The step for forming the emulsion may be carried out by heating the emulsion with the heating rate of 2 to 8° C./min, and preferably 3 to 7° C./min.

In the present invention, the carbon source is a carbon precursor compound that could be carbonized by heat to form the carbon quantum dots. For example, it may be one or more compounds selected from monosaccharides, polysaccharides, carboxylic acids, glycolic acids, and so on. Particularly, the carbon source compound may have the molecular weight of 500 g/mol or less or 60 to 500 g/mol, preferably 350 g/mol or less, and more preferably 200 g/mol or less for the effective emulsion formation. One example of the carbon source may be citric acid. In the embodiment of the present invention, citric acid is carbonized through the polycondensation between molecules by heat and forms the carbon quantum dots.

In the present invention, the surface stabilizer combinable with the quantum dots includes the functional group combinable with the carbon quantum dots, for example, amine group, carboxyl group, thio group, alcohol group, and the like. The surface stabilizer includes 15 to 30 carbons, preferably 16 to 20 carbons, and includes a primary amine at its terminal group. In one preferable embodiment of the present invention, the surface stabilizer may be oleylamine, hexadecylamine, oleic acid, decanol, hexylamine, and the like.

In the present invention, the emulsion including the carbon source means the form that the carbon sources or the droplets including the carbon source are dispersed in the oily dispersion medium. Particularly, the emulsion may be an emulsion of a polar solvent such as water surrounded by the molecules of the surface stabilizer in a non-polar solvent such as a hydrocarbon. And, the size of the droplets may be controlled by changing the volume ratio of water and the surface stabilizer because the size of the emulsion may be determined by the volume ratio of water and the surface stabilizer. In the preferable embodiment of the present invention, the emulsion may be a microemulsion having the diameter of micrometer order and the diameter may be 0.01 μm to 1000 μm preferably. Here, the mole ratio of the oily non-polar solvent and the surface stabilizer, namely the ratio of non-polar solvent:surface stabilizer may be 5:5 to 9.9:0.1, preferably 7:3 to 9:1. When the volume ratio of the surface stabilizer becomes large, the size of the droplets may become small. And, the molar concentration of the emulsion including the carbon source may be 0.1 M to 10 M, preferably 1 M to 8 M, and more preferably 5 M. When the volume ratio of the surface stabilizer becomes large like this, the size of the droplets may become small.

In the present invention, the non-polar solvent may be a C₁-C₂₅ hydrocarbon, and for example, a solvent such as octadecene may be used preferably. Furthermore, the polar solvent may be water, acetone, methanol, and the like, and water may be used preferably.

Meanwhile, the carbon quantum dots may be formed by heating the emulsion at 200° C. or more or 200 to 400° C. for 90 mins or more or 90 to 360 mins and carbonizing the carbon source after forming the emulsion in which the carbon source is dispersed. The carbonization process may be carried out preferably at 210° C. or more or 210 to 350° C., and more preferably at 220° C. or more or 220 to 300° C. And, the carbonization step may be carried out preferably for 105 mins or more or 105 to 300 mins, and more preferably for 120 mins or more or 150 to 240 mins.

The carbonization step may be carried out at 200° C. or more for 90 mins or more in the aspect of synthesizing the carbon quantum dots having uniform size and structure on the whole. And, the process may be carried out at 400° C. or less for about 360 mins or less in the aspect of energy efficiency and cost-cutting of the overall process.

Furthermore, the process for preparing carbon quantum dots according to the present invention may further include the step of precipitating and separating the carbon quantum dots prepared after carrying out the carbonizing step. For example, after adding a water-soluble solvent to the organic solvent in which the carbon quantum dots are dissolved and mixing the same, the organic solvent is settled down and separated from the water-soluble solvent by using a centrifugal separator. Such process is repeated 1 to 6 times. At this time, the water-soluble solvent must be a solvent which does not dissolve the carbon quantum dots but dissolves the unreacted reactants. For example, methanol may be used.

A concrete embodiment of the process for preparing carbon quantum dots according to the present invention is as follows. Referring to FIG. 1, the surface stabilizer solution is prepared by putting the surface stabilizer and the non-polar solvent in a round flask and stirring the same. The carbon source solution is prepared by dissolving the reactants such as monosaccharides, polysaccharides, organic acids, carboxylic acids, glycolic acids, and the like in the polar solvent. The emulsion is prepared by adding the carbon source solution prepared above to the surface stabilizer solution and stirring the same. When the emulsion is formed after the stirring of enough time, gas pipes (gas inlet and gas outlet) are installed. The solution is heated by using a heating plate while inert gas (nitrogen, argon, and so on) streams through the gas pipes. At this time, the temperature of the solution is checked by a thermometer installed in the round flask and controlled, and the reaction is carried out for 10 mins to 6 hrs (FIG. 2). The carbon quantum dots of uniform size according to the present invention can be synthesized through such synthesis process.

Meanwhile, another embodiment of the present invention provides a process for preparing carbon quantum dots doped with non-carbon elements by adding a compound composed of non-carbon elements to the emulsion including the carbon source or by using a compound having carbon and other elements together in the step of synthesizing the carbon quantum dots.

Since the carbon quantum dot shows light emission characteristics by the chromophore that is a complex structure of carbon single bond and double bond, the light emission wavelength can be controlled by changing the chemical structure of the chromophore. Representative method of this is size control but it is difficult to control the size of the chromophore because the binding force between carbons inside the carbon quantum dots is stronger than that of existing heavy metal quantum dots. Hence, new methods are being on the rise, and one of them is the method of doping the chromophore with non-carbon elements. Therefore, the present inventors recognized that the properties of the carbon quantum dots can be controlled by adding a specific non-carbon compound in the step of synthesizing the carbon quantum dots, and accomplished said another embodiment of the present invention.

First, among the processes for preparing carbon quantum dots according to the present invention, the process of adding the compound composed of non-carbon elements to the emulsion including the carbon source may include the steps of heating a dispersion solution including a carbon source compound and a surface stabilizer at 80 to 180° C. for 20 mins or more to form an emulsion in which a carbon source is dispersed; and heating the emulsion at 200° C. or more for 90 mins or more to carbonize the carbon source, wherein the emulsion further includes a compound including one or more non-carbon elements selected from the group consisting of nitrogen, sulfur, phosphorus, boron, lithium, zinc, and aluminum.

According to the present invention, in the process for preparing carbon quantum dots by adding the compound composed of non-carbon elements to the emulsion including the carbon source, the kind and the property of the surface stabilizer and the carbon source compound, the content, the characteristics of the emulsion, the synthesis condition, and so on are the same as disclosed above.

The non-carbon elements compound added for doping the carbon quantum dots may be a compound including one or more non-carbon elements selected from the group consisting of nitrogen, sulfur, phosphorus, boron, lithium, zinc, and aluminum, and preferably a compound including non-carbon element such as nitrogen, sulfur, and so on. The compound including non-carbon elements may be a water soluble amine, thiol, phosphoric acid, boride, and so on, and ethylene diamine may be used as an example. The non-carbon element compound may be a hydrophilic component.

The non-carbon element compound may be added in the concentration of 1/20 to 1 times, preferably 1/5 to 1 times, based on the concentration of the reactant including the carbon source compound. Also, the non-carbon element compound may be added and reacted in the contents of 5 to 100 parts by weight, preferably 20 to 100 parts by weight, based on 100 parts by weight of the carbon source compound.

According to the present invention, a concrete embodiment of the process for preparing the carbon quantum dots by adding the compound composed of non-carbon elements to the emulsion including the carbon source compound is as follows. Referring to FIG. 1, the surface stabilizer solution is prepared by putting the surface stabilizer and the non-polar solvent in a round flask and stirring the same. The carbon source solution is prepared by dissolving the reactants such as monosaccharides, polysaccharides, organic acids, carboxylic acids, glycolic acids, and the like in the polar solvent, and then the compound such as amine, thiol, phosphoric acid, boride, and the like is added to and mixed with the carbon source solution for doping the carbon quantum dots with other elements. The emulsion is prepared by adding the solution prepared above to the surface stabilizer solution and stirring the same. When the emulsion is formed after the stirring of enough time, gas pipes (gas inlet and gas outlet) are installed. The solution is heated by using a heating plate while inert gas (nitrogen, argon, and so on) streams through the gas pipes. At this time, the temperature of the solution is checked by a thermometer installed in the round flask and controlled, and the reaction is carried out for 10 mins to 6 hrs (FIG. 2). The carbon quantum dots of uniform size doped with other elements (nitrogen, sulfur, phosphorus, boron, and so on) according to the present invention can be synthesized through such synthesis process. The characteristics of the carbon quantum dot doped like this are different from existing carbon quantum dots and it has high probability of being used to various application fields.

Furthermore, among the processes of preparing carbon quantum dots according to the present invention, the process by using a carbon source compound comprising carbon element and other elements not carbon, namely non-carbon elements, may include the steps of heating a dispersion solution including a carbon source compound and a surface stabilizer at 80 to 180° C. for 20 mins or more to form an emulsion in which a carbon source is dispersed; and heating the emulsion at 200° C. or more for 90 mins or more to carbonize the carbon source, wherein the carbon source compound further includes one or more non-carbon elements selected from the group consisting of nitrogen, sulfur, phosphorus, boron, zinc, and aluminum.

According to the present invention, in the process for preparing carbon quantum dots by using the compound having carbon and non-carbon element together, the kind and the property of the surface stabilizer, the content, the characteristics of the emulsion, the synthesis condition, and so on are the same as disclosed above.

Here, the compound including carbon and non-carbon elements may be a compound including one or more non-carbon elements selected from the group consisting of nitrogen, sulfur, phosphorus, boron, zinc, and aluminum in addition, and preferably a compound including non-carbon element such as nitrogen, sulfur, phosphorus, boron, and so on in addition. Particularly, the compound including carbon and other elements may be monosaccharides, polysaccharides, organic acids, carboxylic acids, and glycolic acids, and for example, one or more compounds selected from the group consisting of ethylenedithiodiacetic acid, ethylenediamine-N,N′-diacetic acid, zinc acetate, and aluminum triacetate. Furthermore, the carbon source compound may be a hydrophilic component.

According to the present invention, a concrete embodiment of the process for preparing carbon quantum dots by using the compound having carbon and non-carbon element together is as follows. Referring to FIG. 1, the surface stabilizer solution is prepared by putting the surface stabilizer and the non-polar solvent in a round flask and stirring the same. The carbon source solution is prepared by dissolving the reactants such as monosaccharides, polysaccharides, organic acids, carboxylic acids, glycolic acids, and the like including non-carbon elements such as nitrogen, sulfur, phosphorus, boron, zinc, and aluminum in the polar solvent. The emulsion is prepared by adding the solution prepared above to the surface stabilizer solution and stirring the same. When the emulsion is formed after the stirring of enough time, gas pipes (gas inlet and gas outlet) are installed. The solution is heated by using a heating plate while inert gas (nitrogen, argon, and so on) streams through the gas pipes. At this time, the temperature of the solution is checked by a thermometer installed in the round flask and controlled, and the reaction is carried out for 10 mins to 6 hrs (FIG. 2). The carbon quantum dots of uniform size doped with other elements (nitrogen, sulfur, phosphorus, boron, and so on) according to the present invention can be synthesized through such synthesis process. The characteristics of the carbon quantum dot doped like this are different from existing carbon quantum dots and it has high probability of being used to various application fields.

Meanwhile, still another embodiment of the present invention provides a method of modifying the surface of the carbon quantum dots by using a specific surface stabilizer after carrying out the step of synthesizing the carbon quantum dots as disclosed above.

As disclosed above, it is possible to dope the carbon quantum dots with non-carbon elements in order to control the chromophore but another method besides the doping method is a method of replacing the existing surface stabilizer with a surface stabilizer which can function as an auxochrome for controlling the chemical structure of the chromophore of the carbon quantum dots. Furthermore, the carbon quantum dots can be dissolved in an organic solvent when a surface stabilizer having an alkyl chain is used, but they can be dissolved even in an aqueous solution by replacing the existing surface stabilizer with a surface stabilizer having a water-soluble compound. Therefore, the easy doping method and the replacement method of the surface stabilizer are continuously being required. The present inventors recognized that the properties of the carbon quantum dots can be controlled by adding a solution of a surface stabilizer compound for the replacement to the solution after synthesizing the carbon quantum dots, and accomplished said still another embodiment of the present invention.

Particularly, existing surface stabilizers have alkyl chains but the surface stabilizer for the replacement used in the additional step of modifying the surface according to the present invention has various functional groups. For example, it may have the functional groups such as methylthio, methyloxide, bromine, and the like. Such functional groups can function as an auxochrome and can change the light emission characteristics of the carbon quantum dots.

The method of replacing the surface stabilizer of the carbon quantum dots according to the present invention is characterized in including the steps of heating a dispersion solution including a carbon source compound and a surface stabilizer at 80 to 180° C. for 20 mins or more to form an emulsion in which a carbon source is dispersed; and heating the emulsion at 200° C. or more for 90 mins or more to carbonize the carbon source; and reacting the carbon quantum dots prepared through the carbonizing step with one or more surface stabilizers selected from the group consisting of a C₁-C₂₅ alkylamine, a C₀-C₂₅ alkylbenzylamine, a C₁-C₂₅ carboxylic acid, a C₁-C₂₅ alcohol, and a C₁-C₂₅ thiol to modify the surface of the carbon quantum dots.

In the present process for preparing carbon quantum dots by including the process of replacing the surface stabilizer, the kind and the property of the surface stabilizer and the carbon source compound, the content, the characteristics of the emulsion, the synthesis condition, and so on are the same as disclosed above.

In the present invention, the surface stabilizer for the replacement reacts with the carbon quantum dots by an equilibrium reaction when the solution of the surface stabilizer solution is mixed with the carbon quantum dots solution. Furthermore, the surface stabilizer reacts with the carbon quantum dots by a surface reaction when the solution is not mixed with the carbon quantum dots solution.

The step for the surface modification may be carried out by adding the solution including the surface stabilizer to the solution including the carbon quantum dots and heating the same. The heating step may be carried out at the temperature range from the boiling point or more of the solution including the carbon quantum dots to the boiling point or less of the solution including the compound including non-carbon elements.

The concentration of the surface stabilizer compound may be 0.01 to 10,000 times the concentration of the carbon quantum dots in the solution, the heating range may be 50° C. to 250° C., and the reaction time may be 10 mins to 48 hrs. Preferably, the heating step may be carried out at 100° C. to 250° C. for 10 mins to 36 hrs.

Each of the carbon quantum dot solution and the surface stabilizer solution may include one or more solvents selected from the group consisting of water, alcohol, acetone, hexane, octane, toluene, chloroform, chlorobenzene, dimethylformamide (DMF), and tetrahydrofuran (THF).

In the present invention, the water-soluble carbon quantum dots may be prepared by replacing the oleophilic surface stabilizer attached to the carbon quantum dots with the hydrophilic surface stabilizer.

The surface stabilizer compound may be amine, carboxylic acid, alcohol, thiol, and the like, which has carbon atoms of 1 to 25 and one or more water-soluble functional groups such as hydroxyl group, carboxyl group, carbonyl group, and the like at the opposite side of the compound. For example, it may be ethanolamine, glycine, and the like. Here, the surface stabilizer compound may be a compound that is not long chains and has the water-soluble functional group at the ending site of the compound. Of course, it may have the functional group such as amine group which can bond to the carbon quantum dots at the other ending site of the compound.

In the present invention, the energy structure can be changed by replacing the resultant surface stabilizer from the synthesis step with a new surface stabilizer which can function as a chromophore or an auxochrome.

The new surface stabilizer compound may be amine including hydrocarbon group, amine including benzyl group, carboxylic acid including benzyl group, alcohol including benzyl group, thiol including benzyl group, and so on, which have carbon atoms of 1 to 25 and one or more chromophore substituents such as amine, thiol, methoxy, bromine, fluorine, chlorine, and the like on the opposite side of the compound. For example, p-methylthioaniline, p-anisidine, N,N′-dimethyl-p-phenylenediamine, p-bromoaniline, and the like may be used. Here, the surface stabilizer compound may be a surface stabilizer having functional groups including non-carbon elements at the ends and a benzene ring in the middle. Of course, it may have the functional group such as amine group which can bond to the carbon quantum dots at the other end of the compound.

Furthermore, the present invention may further include the step of separating and eliminating impurities from the carbon quantum dots through dialysis or purification after the heating step.

According to the present invention, a concrete embodiment of the process for preparing carbon quantum dots by replacing the surface stabilizer is as follows. First, referring to FIG. 1, the carbon quantum dots can be synthesized through the processes of preparing the surface stabilizer solution and the carbon source solution respectively, mixing the solutions for preparing the emulsion, and carbonizing the carbon source. After separating the carbon quantum dots synthesized like this, the process of replacing the surface stabilizer may be carried out in addition. At this time, the organic solvent of low boiling point and the surface stabilizer compound of high boiling point that will be used for the replacement are selected. After dissolving the carbon quantum dots obtained through said synthesis process in the organic solvent of low boiling point, the temperature is raised with adding the surface stabilizer compound of high boiling point thereto and stirring the same. At this time, the temperature is raised to between the boiling points of the organic solvent and the surface stabilizer compound. After time passed, the organic solvent vapors up and the carbon quantum dots exist in the form of being dissolved in the surface stabilizer compound or being solidified. When the organic solvent and the surface stabilizer are mixed well, the earlier surface stabilizer is detached from the carbon quantum dots and the new surface stabilizer is easily attached to the carbon quantum dots by the principle of chemical equilibrium and high temperature. On the contrary, when the organic solvent and the surface stabilizer compound are not mixed well, the earlier surface stabilizer is detached from the carbon quantum dots and the new surface stabilizer is attached to the carbon quantum dots by the surface reaction at the interface of between the two phases and high temperature. Then, the carbon quantum dots substituted with the new surface stabilizer can be obtained finally by dissolving the product obtained above in an organic solvent again and dialyzing the same for eliminating the nonbonded surface stabilizer compound.

Meanwhile, still another embodiment of the present invention provides a carbon quantum dot prepared by the method disclosed above. The carbon quantum dot of the present invention has uniform size distribution in company with excellent optical and electric characteristics and durability because it is prepared by using an emulsion.

Particularly, since the carbon quantum dot of the present invention can be dissolved in an organic solvent in contrast with existing carbon quantum dots, it can be applied not only to specific application fields such as bio-imaging but also to electronic devices such as solar cells or organic light emitting devices. And, since aggregation does not happen to the carbon quantum dots because of the surface stabilizer, the reaction yield rate and the quantum yield rate are very higher than them of an existing one and the stability in air is also very high. Furthermore, it has an advantage in that the doping method is very simply carried out by just adding other compound to the solution of the carbon source solution, the reactant.

And, when the carbon quantum dot of the present invention is exposed to UV light, for example, the light of the wavelength of 250 nm to 600 nm, it may emit the light of the wavelength of 420 nm or more or 420 to 650 nm. Particularly, it may also show the light emission characteristics in various wavelengths of 480 nm or more or 480 to 650 nm, preferably 500 nm or more, and more preferably 550 nm or more through the process of replacing the surface stabilizer of the carbon quantum dots.

In the present invention, items besides above disclosure can be added or subtracted with necessity and the present invention does not limit them particularly.

### Advantageous Effects

The process for preparing carbon quantum dots according to the present invention makes a mass production and a process simplification possible by using an emulsion and shows excellent reaction yield rate.

The process for preparing carbon quantum dots according to the present invention can control the size of the carbon quantum dots efficiently and unconstrainedly.

The process for preparing carbon quantum dots according to the present invention can prepare carbon quantum dots having uniform size and excellent quantum yield rate.

The process of doping the carbon quantum dots according to the present invention is simple because it is carried out in the process of synthesizing the carbon quantum dots without a separate process. Furthermore, the process can dope the carbon quantum dots with various kinds of elements by using various compounds soluble in an aqueous solution and shows excellent reaction yield rate.

The process of replacing the surface stabilizer of the carbon quantum dots according to the present invention is very simple because it goes through only two simple steps, and shows excellent replacement ratio.

The process of replacing the surface stabilizer of the carbon quantum dots according to the present invention can provide the carbon quantum dots soluble in an aqueous solution through a simple process by replacing the surface stabilizer with a hydrophilic compound.

The process of doping the carbon quantum dots or by replacing the surface stabilizer with a compound which can function as a chromophore or an auxochrome according to the present invention can provide the carbon quantum dots having the light emission characteristics different from existing carbon quantum dots.

### BRIEF DESCRIPTION OF DRAWINGS

FIG. 1 shows the schematic drawing of the reaction apparatus according to the present invention.

FIG. 2 shows the mimetic diagram showing the synthesis of the carbon quantum dots in the emulsion; (a) formation of the emulsion, (b) polycondensation, and (c) carbonization and surface stabilization by oleylamine.

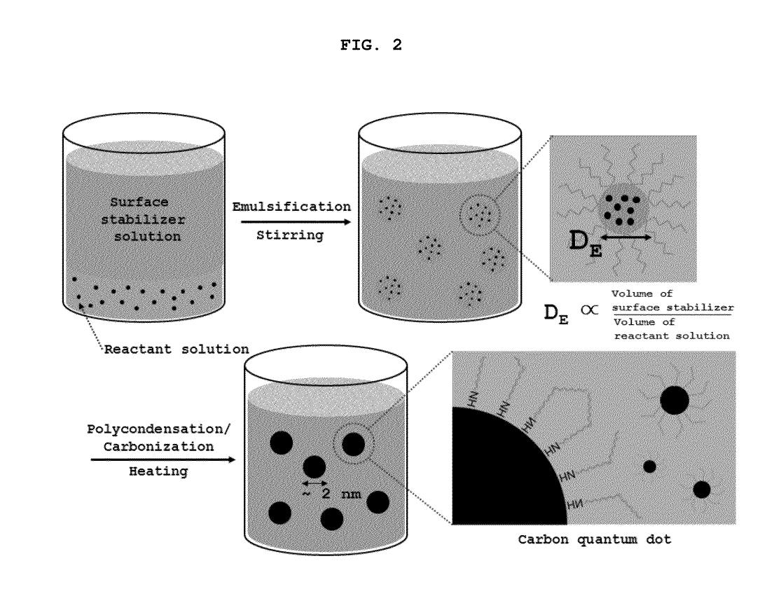

FIG. 3 shows TEM photos (a, b) and distribution histogram (c) of two kinds of carbon quantum dots different in size; (d, e, f, and g) are high resolution TEM photos and the scale bar is 5 nm.

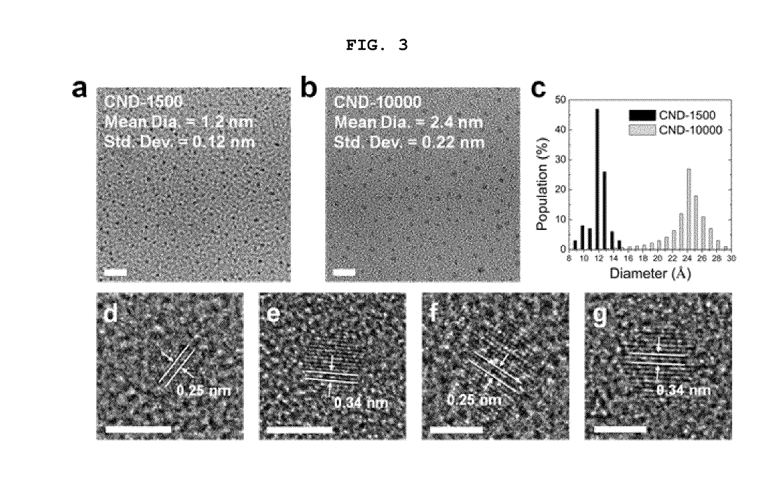

FIG. 4 shows the absorbance and the light emission spectra of two kinds of carbon quantum dots different in size; (a) 1.2 nm carbon quantum dots and (b) 3.0 nm carbon quantum dots.

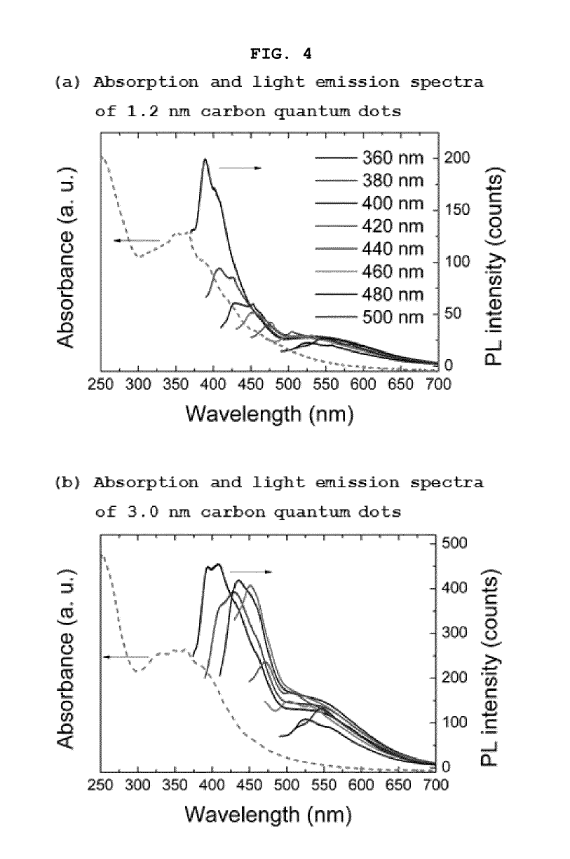

FIG. 5 shows the light emission spectra of the carbon quantum dots according to the dopant elements; (a) carbon quantum dots undoped, (b) carbon quantum dots doped with nitrogen, and (c) carbon quantum dots doped with sulfur.

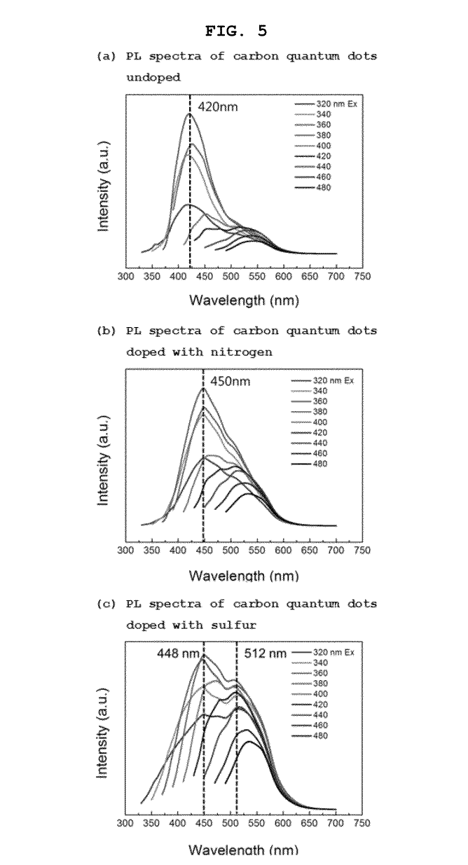

FIG. 6 shows the mimetic diagram of the method of replacing the existing surface stabilizer on the surface of the carbon quantum dots with the new other surface stabilizer; (a) replacing process when the surface stabilizer for the replacement is not mixed well with the solution that the carbon quantum dots are dispersed in the organic solvent and (b) replacing process when the surface stabilizer for the replacement is mixed well with the solution.

FIG. 7 shows the light emission spectra of the carbon quantum dots to which new surface stabilizer is attached; (a) not replaced with the new surface stabilizer and (b) replaced with the new surface stabilizer.

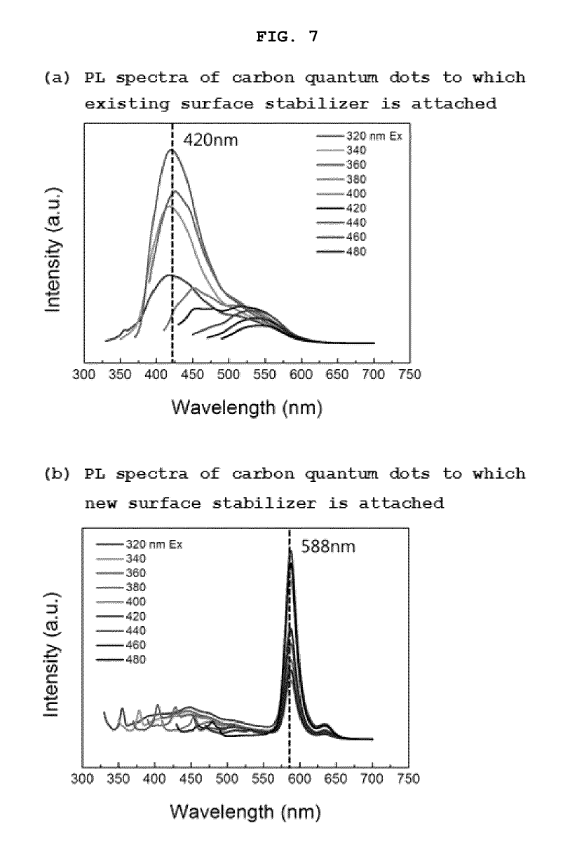

FIG. 8 shows the photos exhibiting the colors of various wavelengths by controlling the characteristics of the carbon quantum dots according to the doping method or the replacing method of the surface stabilizer; (a) light emission by solar light (b) light emission by the light of UV area (360 nm Ex). Particularly, FIG. 8 shows the light emission control of the carbon quantum dots according to the doping method and the surface modification method, here, the leftmost two samples in the photos exhibit the light of the carbon quantum dots synthesized without doping or surface modifying, and the other three samples exhibit the light of the carbon quantum dots made through doping or surface modifying.

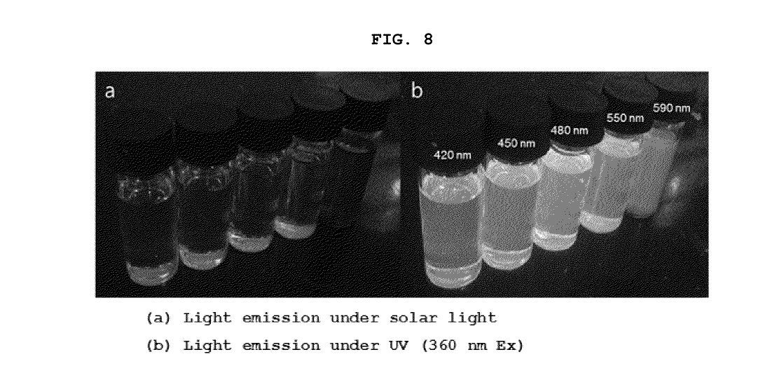

### MODE FOR INVENTION

A better understanding of the present invention may be obtained through the following examples which are set forth to illustrate, but are not to be construed as limiting the present invention.

### EXAMPLES

### Example 1

### Preparation of the Carbon Quantum Dots by Using Oleylamine and Citric Acid

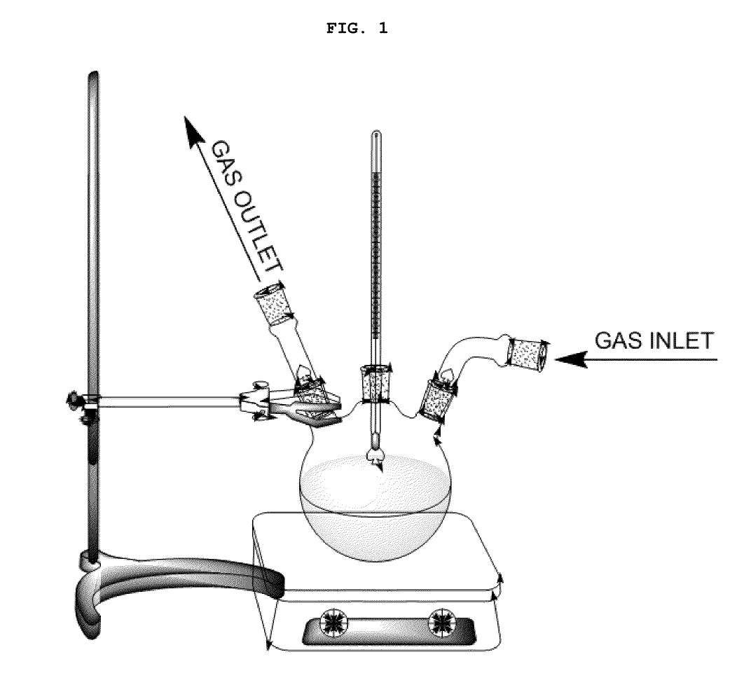

As illustrated in FIG. 1, the colorless transparent surface stabilizer solution was prepared by adding 3 mL of oleylamine and 7 mL of octadecene to a 100 mL round flask and stirring the same for about 5 mins. In isolation from this, the colorless transparent reactant solution was prepared by adding 1 g of citric acid to 1 mL of water in a separate flask and stirring the same for about 10 mins. The emulsion was prepared by putting the reactant solution in the surface stabilizer solution and stirring the same for 20 mins while elevating the temperature from 100° C. with the heating rate of 5° C./min.

When the emulsion was formed after stirring the solution for 20 mins, the gas pipes (gas inlet and gas outlet) were installed and the solution was heated by using a heating plate while argon gas streamed through the gas pipes. The dark brown carbon quantum dots were formed by heating the solution at 250° C. for 2 hrs. The carbon quantum dots in the solution were precipitated by adding several drops of methanol to the solution of the synthesized carbon quantum dots and carrying out a centrifugation separation. The other reactants except the carbon quantum dots were eliminated by repeating the steps of dissolving the precipitated carbon quantum dots in octane and carrying out the centrifugation separation three times. The diameter of the carbon quantum dots was measured by taking TEM photos of the prepared carbon quantum dots after precipitating, washing, and separating the same. The carbon quantum dots having the diameter of 1.2 nm was recognized and the yield rate was 30%.

### Example 2

### Size Control of the Carbon Quantum Dots by Changing the Content of Oleylamine

The colorless transparent surface stabilizer solution was prepared by adding 1 mL of oleylamine and 9 mL of octadecene to a 100 mL round flask and stirring the same for about 5 mins. In isolation from this, the colorless transparent reactant solution was prepared by adding 1 g of citric acid to 1 mL of water in a separate flask and stirring the same for about 10 mins. The emulsion was prepared by putting the reactant solution in the surface stabilizer solution and stirring the same for 20 mins while elevating the temperature from 100° C. with the heating rate of 5° C./min.

When the emulsion was formed after stirring the solution for 20 mins, the gas pipes (gas inlet and gas outlet) were installed and the solution was heated by using a heating plate while argon gas streamed through the gas pipes. The dark brown carbon quantum dots were formed by heating the solution at 250° C. for 2 hrs. The carbon quantum dots in the solution were precipitated by adding several drops of methanol to the solution of the synthesized carbon quantum dots and carrying out a centrifugation separation. The other reactants except the carbon quantum dots were eliminated by repeating the steps of dissolving the precipitated carbon quantum dots in octane and carrying out the centrifugation separation three times. The diameter of the carbon quantum dots was measured by taking TEM photos of the prepared carbon quantum dots after precipitating, washing, and separating the same. The carbon quantum dots having the diameter of 3.0 nm was recognized and the yield rate was 30%.

### Example 3

### Preparation of the Carbon Quantum Dots Doped with Nitrogen by Using Ethylenediamine

The final reactant solution was prepared by adding 9 mmol (3.0 M) of ethylenediamine, a nitrogen compound, to the citric acid solution, the reactant of the synthesis process of the carbon quantum dots, and stirring the same for about 10 mins. In isolation from this, the colorless transparent surface stabilizer solution was prepared by adding 1 mL of oleylamine and 9 mL of octadecene to a 100 mL round flask and stirring the same for about 5 mins. The emulsion was prepared by putting the reactant solution in the surface stabilizer solution prepared like this and stirring the same for 20 mins while elevating the temperature from 100° C. with the heating rate of 5° C./min.

When the emulsion was formed after stirring the solution for 20 mins, the gas pipes (gas inlet and gas outlet) were installed and the solution was heated by using a heating plate while argon gas streamed through the gas pipes. The dark brown carbon quantum dots were formed by heating the solution at 250° C. for 2 hrs. The carbon quantum dots in the solution were precipitated by adding several drops of methanol to the solution of the synthesized carbon quantum dots and carrying out a centrifugation separation. The other reactants except the carbon quantum dots were eliminated by repeating the steps of dissolving the precipitated carbon quantum dots in octane and carrying out the centrifugation separation three times. The light emission characteristics of the doped carbon quantum dots were recognized by measuring the PL of the prepared carbon quantum dots after precipitating, washing, and separating the same. It was recognized that the carbon quantum dots emitted the light of about 25 nm longer wavelength than that of the existing carbon quantum dots.

### Example 4

### Preparation of the Carbon Quantum Dots Doped with Sulfur by Using Ethylenedithiodiacetic Acid

The 5.0M reactant solution was prepared by dissolving ethylenedithiodiacetic acid as the reactant of the synthesis process of the carbon quantum dots in water. In isolation from this, the colorless transparent surface stabilizer solution was prepared by adding 1 mL of oleylamine and 9 mL of octadecene to a 100 mL round flask and stirring the same for about 5 mins. The emulsion was prepared by putting the reactant solution in the surface stabilizer solution prepared like this and stirring the same for 20 mins while elevating the temperature from 100° C. with the heating rate of 5° C./min.

When the emulsion was formed after stirring the solution for 20 mins, the gas pipes (gas inlet and gas outlet) were installed and the solution was heated by using a heating plate while streamed argon gas through the gas pipes. The dark brown carbon quantum dots were formed by heating the solution at 250° C. for 2 hrs. The carbon quantum dots in the solution were precipitated by adding several drops of methanol to the solution of the synthesized carbon quantum dots and carrying out a centrifugation separation. The other reactants except the carbon quantum dots were eliminated by repeating the steps of dissolving the precipitated carbon quantum dots in octane and carrying out the centrifugation separation three times. The light emission characteristics of the doped carbon quantum dots were recognized by measuring the PL of the prepared carbon quantum dots after precipitating, washing, and separating the same. It was recognized that the carbon quantum dots emitted the light of about 25 nm longer wavelength than that of the existing carbon quantum dots and showed the new second peak.

### Example 5

### Preparation of the Carbon Quantum Dots of which the Surface is Modified by Using p-Methylthioaniline

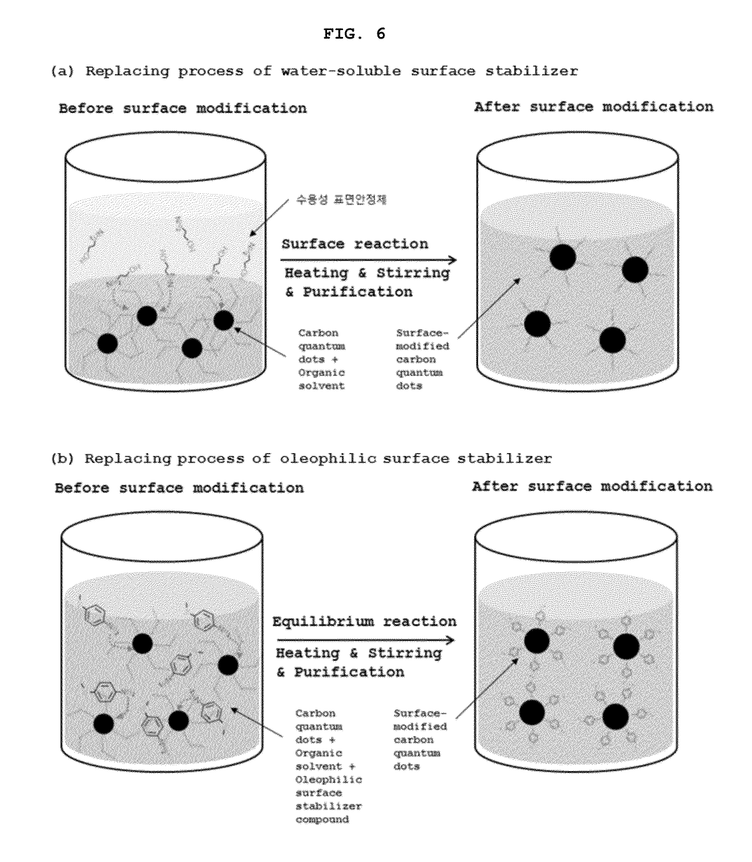

As illustrated in FIG. 6, toluene was selected as the organic solvent having relatively low boiling point and p-methylthioaniline was selected as the surface stabilizer compound for the replacement having high boiling point. After dissolving the synthesized carbon quantum dots in toluene, p-methylthioaniline was added thereto and the solution was heated with stirring. At this time, the temperature was elevated up to 200° C., the temperature between the boiling points of toluene and p-methylthioaniline. After the reaction of 2 days, toluene, the organic solvent, vapored up and the carbon quantum dots were obtained in the form of being dissolved in p-methylthioaniline, the surface stabilizer compound, or being solidified. Finally, the carbon quantum dots of which the surface stabilizer was replaced with p-methylthioaniline were obtained after eliminating the unreacted p-methylthioaniline by dissolving the carbon quantum dots prepared above in toluene again and dialyzing the same.

As disclosed above, the technique about the doping method of the carbon quantum dots of the present invention has an advantage in that there is no additional process because just a reactant is added or changed in the synthesis of the carbon quantum dots. And, since the reaction starts from the molecular state and the other elements can be blended in with the carbon quantum dots, the doping efficiency and the efficiency of the light emission variation are high. Furthermore, the technique about the surface modification method of the carbon quantum dots of the present invention can be effectively carried out because it has only the processes of modifying the surface and filtering impurities. The process of surface modification is not complicated in process because it is carried out by simply adding a new surface stabilizer to the carbon quantum dots solution and heating the same but it has an advantage in that the effect of the surface modification is excellent.

1. A process for preparing carbon quantum dots, including the steps of:
heating a dispersion solution including a carbon source compound and a surface stabilizer at 80 to 180° C. for 20 minutes or more to form an emulsion in which a carbon source is dispersed; and
heating the emulsion at 200° C. or more for 90 minutes or more to carbonize the carbon source,
wherein the emulsion further includes a compound comprising one or more non-carbon elements selected from the group consisting of nitrogen, sulfur, phosphorus, boron, lithium, zinc, and aluminum.

2. The process according to claim 1, wherein the surface stabilizer includes one or more functional groups selected from the group consisting of amine group, carboxyl group, alcohol group, and thiol group.

3. The process according to claim 2, wherein the surface stabilizer is one or more compounds selected from the group consisting of oleylamine, hexadecylamine, oleic acid, decanol, hexadecylthiol, and hexylamine.

4. The process according to claim 1, wherein the carbon source is one or more compounds selected from the group consisting of monosaccharides, polysaccharides, organic acids, carboxylic acids, and glycolic acids.

5. The process according to claim 4, wherein the carbon source is what is polymerized and carbonized.

6. The process according to claim 1, wherein the emulsion is a microemulsion.

7. The process according to claim 1, wherein the emulsion is that droplets including the carbon source are dispersed in the dispersion medium.

8. The process according to claim 7, wherein the emulsion is that aqua droplets including hydrophilic carbon source are dispersed in the dispersion medium of oily phase.

9. The process according to claim 1, wherein the step for forming the emulsion is carried out by heating the dispersion solution with the heating rate of 2 to 8° C./min.

10. The process according to claim 1, wherein the step for forming the emulsion is carried out under the condition of pH 4 to 6.

11. The process according to claim 1, further including the step of precipitating and separating the carbon quantum dots prepared after carrying out the heating step.

12. The process according to claim 1, wherein the compound including non-carbon elements is hydrophilic.

13. The process according to claim 1, wherein the compound including non-carbon elements is added and reacted in the concentration of 1/20 to 1 times as much as the reactant including the carbon source compound.

14. The process according to claim 1, wherein the compound including non-carbon elements is added and reacted in the content of 5 to 100 parts by weight per 100 parts by weight of the carbon source compound.

15. A process for preparing carbon quantum dots, including the steps of:
heating a dispersion solution including a carbon source compound and a surface stabilizer at 80 to 180° C. for 20 minutes or more to form an emulsion in which a carbon source is dispersed; and
heating the emulsion at 200° C. or more for 90 minutes or more to carbonize the carbon source,
wherein the carbon source compound further includes one or more non-carbon elements selected from the group consisting of nitrogen, sulfur, phosphorus, boron, zinc, and aluminum.

16. The process according to claim 15, wherein the carbon source is one or more compounds selected from the group consisting of monosaccharides, polysaccharides, organic acids, carboxylic acids, and glycolic acids, and further includes one or more non-carbon elements selected from the group consisting of nitrogen, sulfur, phosphorus, boron, zinc, and aluminum.

17. The process according to claim 16, wherein the carbon source is one or more compounds selected from the group consisting of ethylenedithiodiacetic acid, ethylenediamine-N,N′-diacetic acid, zinc acetate, and aluminum triacetate.

18. The process according to claim 16, wherein the carbon source compound is hydrophilic.

19. A process for preparing carbon quantum dots, including the steps of:
heating a dispersion solution including a carbon source compound and a surface stabilizer at 80 to 180° C. for 20 minutes or more to form an emulsion in which a carbon source is dispersed; and
heating the emulsion at 200° C. or more for 90 minutes or more to carbonize the carbon source; and
reacting the carbon quantum dots prepared through the carbonizing step with one or more surface stabilizers selected from the group consisting of a C₁-C₂₅ alkylamine, a C₀-C₂₅ alkylbenzylamine, a C₁-C₂₅ carboxylic acid, a C₂-C₂₅ alcohol, and a C₂-C₂₅ thiol to modify the surface of the carbon quantum dots.

20. The process according to claim 19, wherein the surface stabilizer further includes one or more water-soluble substituents selected from the group consisting of hydroxyl group, carboxyl group, carbonyl group, and amine group.

21. The process according to claim 20, wherein the surface stabilizer is one or more compounds selected from the group consisting of ethanolamine and glycine.

22. The process according to claim 19, wherein the surface stabilizer further includes one or more chromophore substituents selected from the group consisting of amine, thiol, methoxy, fluorine, bromine, and chlorine.

23. The process according to claim 22, wherein the surface stabilizer is one or more compounds selected from the group consisting of p-methylthioaniline, p-anisidine, N,N′-dimethyl-p-phenylenediamine, and p-bromoaniline.

24. The process according to claim 19, wherein the step for modifying the surface is carried out by adding the surface stabilizer solution to the carbon quantum dot solution and heating the same.

25. The process according to claim 24, wherein each of the carbon quantum dot solution and the surface stabilizer solution includes one or more solvents selected from the group consisting of water, alcohol, acetone, hexane, octane, toluene, chloroform, chlorobenzene, dimethylformamide (DMF), and tetrahydrofuran (THF).

26. The process according to claim 24, wherein the step for modifying the surface is carried out at the temperature from the boiling point or more of the carbon quantum dot solution to the boiling point or less of the surface stabilizer solution.

27. The process according to claim 24, wherein the heating step is carried out at 50° C. to 250° C.

28. The process according to claim 24, wherein the reaction time of the heating step is 10 minutes to 48 hours.

29. The process according to claim 19, further including the step of separating and eliminating impurities from the carbon quantum dots through dialysis or purification after the step for modifying the surface.

30. A carbon quantum dot prepared by the process according to claim 1.
